(19) United States
(12) Patent Application Publication
(10) Pub. No.: US 2018/0312441 A1
(43) Pub. Date: Nov. 1, 2018

(54) Thermal shock-resistant composite materials

(71) Applicant: CeramTec GmbH, Plochingen (DE)

(72) Inventors: Lukas GOTTWIK, Bad Boll (DE); Thomas BETZ, Weiden (DE); Claus Peter KLUGE, Röslau (DE); Meinhard KUNTZ, Esslingen (DE); Reinhard LENK, Dresden (DE)

(21) Appl. No.: 15/774,099

(22) PCT Filed: Nov. 10, 2016
(86) PCT No.: PCT/EP2016/077298

§ 371 Date: May 7, 2018

(30) Foreign Application Priority Data
Nov. 10, 2015 (DE) 10 2015 222 143.1

(51) Int. Cl. C04B 35/488

(52) U.S. Cl. CPC C04B 35/488; C04B 2235/3244; C04B 2235/785; C04B 2235/762; C04B 2235/9607; C04B 2235/765; C04B 2235/786

(57) ABSTRACT

The invention relates to a ceramic composite material and to the production and use thereof. The invention especially relates to a zirconium oxide-based composite material, a homogeneous multiphase polycrystalline ceramic material.

The invention relates to a ceramic composite material and to the production and use thereof. The invention especially relates to a zirconium oxide-based composite material, a homogenous, multiphase, and polycrystalline ceramic material.

Composite materials based on zirconium oxide, especially materials having additional components such as stabilizers or secondary phases, have been known for quite some time. These materials are used in the automobile industry for producing lambda sensors, for instance. The problem with these materials is that they must withstand high temperatures, but they are also subject to fluctuations in temperature, so that this may lead to the destruction of the component. In particular thermal shock loads, such as for instance contact with condensation water, may result in significant damage or even destruction.

Moreover, the higher requirements for lambda sensors based on the more stringent EURO 6 regulation is problematic for the known materials. These new regulations require higher heating rates for the operating temperature within a few seconds, but these rates can hardly be achieved using the known materials.

The object was therefore to provide a material that is less susceptible to destruction at the temperature changes occurring. In particular, the material should have a high and improved thermal shock resistance.

The object is attained using a (sintered) composite material having the features listed in claim 1. Preferred embodiments are listed in the subordinate claims.

The inventive composite material is distinguished from the prior art by an improved resistance to thermal shock. In addition, it was surprisingly found that, in addition to an increase in strength, it was possible to attain an equivalent or even greater ion conductance despite a decrease in the mean microstructure crystallite size.

Due to its ion conductive property, the inventive composite material may also be used as an oxygen sensor. The typical field of application is, e.g., the lambda sensor in the automobile or electronics sector. In these cases, the inventive composite material may be used in the form of sintered films as components in the lambda sensor.

The composition for producing the inventive composite material, i.e., the mixture of the ceramic powders included in the composite material, including the possible additives, may be molded into a green body prior to the sintering. The composite material may then be present in particular as a green body in the form of a film that occurs, for instance or in particular, using film casting. The thickness of the film depends on the field of use and is between 10 μm and 1 mm preferably between 100 μm and 600 μm.

In one preferred embodiment, the invention relates to a composite material comprising a ceramic matrix made of zirconium oxide and at least one secondary phase dispersed therein, characterized in that the matrix made of zirconium oxide makes up a portion of at most 99 percent by weight of the composite material, and in that the secondary phase makes up a portion of 1 to 30 percent by weight of composite material, preferably 1-15 percent by weight, particularly preferably 1-5 percent by weight, wherein the zirconium oxide, relative to the total zirconium oxide portion, is present, essentially, in the tetragonal and cubic phase, preferably at 90 to 99%, more preferably at 95 to 99%, and particularly preferably at 98 to 99%, and wherein the tetragonal and cubic phase of the zirconium oxide is chemically and/or mechanically stabilized.

Mechanical stabilization shall be construed to mean that the inventive addition of the secondary phases, which addition during the conversion of the tetragonal crystal structure to the monoclinic crystal structure of the zirconium oxide, compensates extension that occurs in that micro-movements/micro-shears are possible in an otherwise comparatively rigid ceramic structure without it being necessary for macroscopic tears to occur.

Moreover, mechanical stabilization shall also be construed to mean that the tetragonal crystal phase of the zirconium oxide is stabilized by mechanical tensions in the overall microstructure. Different coefficients of thermal expansion of ZrO2 and secondary phase during cooling after the sintering process may lead to such tensions. According to the invention, the matrix made of zirconium oxide in the composite material may have a microstructure grain size of an average of 0.5 to 2.0 μm, preferably an average of 0.5 to 1.5 μm. The microstructure grain size is determined as the “mean linear intercept distance” by means of the linear intercept method according to EN 623-3 (2003 January).

The composite material according to the invention may include one or a plurality of chemical stabilizers. The chemical stabilizers are selected from the group comprising MgO, CaO, CeO₂, Gd₂O₃, Sm₂O₃, Er₂O₃, Y₂O₃, Yb₂O₃, and Sc₂O₃, or mixtures thereof, wherein the total content of chemical stabilizers is <12 mol % relative to the zirconium oxide content, preferably <10 mol %, particularly preferably <5 mol %.

The composite material according to the invention may contain additional components, in particular the zirconium oxide and/or the secondary phase may contain soluble components. Soluble components may be, e.g., Cr, Fe, Mg, Ca, Ti, Si, Y, Ce, lanthanides, and/or V. These components may, for one thing, function as dye additives, and, for another thing, as sintering aids. As a rule, they are added as oxides.

The secondary phase of the inventive composite material may also include dispersoids that, due to their crystal structure, permit shear deformations at the microscopic level and/or improve the mechanical properties.

In one preferred embodiment, the microstructure grain sizes of the secondary phase are less than or equal in size to the microstructure grain sizes of the zirconium oxide, wherein the microstructure grain sizes (d50) are preferably 0.1 to 2.0 μm, preferably 0.1 to 1.5 μm, particularly preferably 0.1 to 0.5 μm. The microstructure grain sizes may also be determined with the linear intersection method.

The secondary phase is in particular one or a plurality of the following compounds selected from the group comprising strontium aluminate (SrAl₂O₄ or SrAl₁₂O₁₉), lanthanum aluminate (LaAlO₃ or LaAl₁₁O₁₈), spinel (MgAl₂O₄), aluminum oxide (Al₂O₃), zirconium silicate (ZrSiO₄), K feldspar (KalSi₃O₈), and lanthanum phosphate (La(PO)₄), preferably strontium aluminate, aluminum oxide, and zirconium silicate, particularly preferably zirconium silicate.

In one particularly preferred embodiment, the inventive material may also have a tertiary phase. The latter may be selected from the compounds cited in the foregoing for the secondary phase.

According to the invention, the composite material may be produced using very different methods, preferably using film casting, extrusion, dry pressing, additive manufacturing methods, and/or other molding methods such as, for example, slip casting or injection molding.

To obtain the composite material, the raw material mixture is then sintered, wherein the sintering is performed at temperatures <1670° C., preferably <1530° C., particularly preferably <1400° C.

The inventive composite material is significantly better in its characteristic properties. In particular, the composite material preferably has a four-point flexural strength ≥600 MPa according to DIN EN 843-1 (version EN 843-1: 2006/edition August 2008).

One feature for evaluating high performance ceramics is the “flaw tolerance.” The test is performed using the “Indentation Strength Method” described in detail in the literature (see R. F. Cook, Multi-Scale Effects in the Strength of Ceramics, J. Am. Ceram. Soc. 98 [1] 2933-2947 (2015) and P. Chantikul, G. R. Anstis, B. R. Lawn, D. B. Marshall, A Critical Evaluation of Indentation Techniques for Measuring Fracture Toughness: II Strength Method, J. Am. Ceram. Soc. 64 [9], 539-543 (1981).

The established method and procedure was worked out using different materials. It was found that this test is very well reproducible and may be considered informative with respect to the technically relevant reinforcing mechanisms, for instance transformation toughening. The separation precision in terms of material variants is significantly more reliable than, for instance, measurements of fracture toughness using the SEVNB test.

In the test itself, 3 indentations having the same load on the traction side of bending bars are made within the upper rollers. Then the bending bars damaged in a defined manner are stored in water for at least three days (saturation of sub-critical fracture propagation). Then the residual strength is determined analogous to a normal bending test.

The damage tolerance or residual strength of the inventive composite material following HV5 indentation is >170 MPa, preferably >190 MPa, and in particular preferably >200 MPa. The damage tolerance or residual strength of the inventive composite material following HV20 indentation is >100 MPa, preferably >110 MPa, and particularly preferably >120 MPa.

In addition, the composite material according to the invention has electrical conductivity of ≥2.0 S/m at 850° C. and of ≥5.0 S/m at 1000° C., preferably ≥6.0 S/m at 1000° C.

The fracture penetration test according to a thermal shock treatment based on DIN EN 820-3 (version EN 820-3: 2004/edition November 2004) has a particularly positive result with the inventive composite materials compared to the known material from the prior art. The thermal shock resistance was determined using quenching tests on fasted bending rods. At a temperature difference of 220° C., the inventive composite material did not exhibit any damage. In contrast, the material from the prior art showed fracture formation following thermal tensions.

The inventive composite material is preferably used in electrical engineering and sensors, in particular for producing oxygen sensors, particularly preferably as a precursor product or as a component of the lambda sensor in the form of unsintered ZrO₂ films and is present in a lambda sensor following production as a component.

1. A composite material, comprising a ceramic matrix made of zirconium oxide and dispersed therein at least one secondary phase, wherein the matrix made of zirconium oxide makes up a portion of at most 99 percent by weight of the composite material, and in that the secondary phase makes up a portion of 1 to 30 percent by weight of composite material, preferably 1-15 percent by weight, particularly preferably 1-5 percent by weight, wherein the zirconium oxide, relative to the total zirconium oxide portion, is present, essentially, in the tetragonal and cubic phase, preferably at 90 to 99%, more preferably at 95 to 99%, and particularly preferably at 98 to 99%, and wherein the tetragonal and cubic phase of the zirconium oxide is chemically and/or mechanically stabilized.

2. The composite material according to claim 1, wherein the matrix made of zirconium oxide has a microstructure grain size of an average of 0.5 to 2.0 μm, preferably an average of 0.5 to 1.5 μm.

3. The composite material according to claim 1, wherein included as chemical stabilizers are MgO, CaO, CeO2, Gd2O3, Sm2O3, Er2O3, Y2O3, Yb2O3, and Sc2O3, or mixtures thereof, wherein the total content of chemical stabilizers is <12 mol % relative to the zirconium oxide content, preferably <10 mol %, particularly preferably <5 mol %.

4. The composite material according to claim 1, wherein the zirconium oxide and/or the secondary phase includes soluble components.

5. The composite material according to claim 1, wherein the microstructure grain size of the secondary phase is less than or equal in size to the microstructure grain size of the zirconium oxide, wherein the microstructure grain size is preferably 0.1 to 2.0 μm, more preferably 0.1 to 1.5 μm, particularly preferably 0.1 to 0.5 μm.

6. The composite material according to claim 1, wherein the secondary phase is selected from one or a plurality of the following compounds: strontium aluminate (SrAl2O4 or SrAl12O19), lanthanum aluminate (LaAlO3 or LaAl11O18), spinel (MgAl2O4), aluminum oxide (Al2O3), zirconium silicate (ZrSiO4), K feldspar (KalSi3O8), and lanthanum phosphate (La(PO)4), preferably strontium aluminate, aluminum oxide, and zirconium silicate, particularly preferably zirconium silicate.

7. The composite material according to claim 1, wherein the composite material is produced by sintering the raw material mixture at temperatures <1670° C., preferably <1530° C., particularly preferably <1400° C.

8. The composite material according to claim 1, wherein the composite material has a four-point flexural strength ≥600 MPa according to DIN EN 843-1 (version EN 843-1: 2006/edition August 2008).

9. The composite material according to claim 1, wherein its electrical conductivity is ≥2.0 S/m at 850° C. and ≥5.0 S/m at 1000° C., preferably ≥6.0 S/m at 1000° C.

10. A use of the composite material according to claim 1 in electrical engineering or sensors, in particular for producing oxygen sensors, particularly preferably as a precursor product or as a component of the lambda sensor in the form of unsintered ZrO2 films.
